(19) United States
(12) Patent Application Publication
(10) Pub. No.: US 2026/0186353 A1
(43) Pub. Date: Jul. 2, 2026

(54) DISPLAY DEVICE

(71) Applicant: LG Display Co., Ltd., Seoul (KR)

(72) Inventors: Jaebin SONG, Seoul (KR); Junsik HWANG, Paju-si (KR); SungHee KIM, Paju-si (KR)

(73) Assignee: LG Display Co., Ltd., Seoul (KR)

(21) Appl. No.: 19/381,902

(22) Filed: Nov. 6, 2025

(30) Foreign Application Priority Data
Dec. 26, 2024 (KR) 10-2024-0197139

(51) Int. Cl. G02F 1/1345; G02F 1/1333; G02F 1/1335

(52) U.S. Cl. CPC G02F 1/1345; G02F 1/13338; G02F 1/133528; G02F 2202/22

(57) ABSTRACT

Provided is a display device. A display device according to an exemplary embodiment of the present disclosure includes a display panel, a first polarizing plate disposed below the display panel, a second polarizing plate disposed on the display panel, and an antistatic film disposed between the display panel and the second polarizing plate, in which the antistatic film includes a silicon-based matrix, and a polythiophene-based compound and a carbon nanotube dispersed in the silicon-based matrix, and the carbon nanotube is a water-dispersible carbon nanotube. A display device according to the present disclosure includes, as a conductive material, an antistatic film containing a low-cost polythiophene-based compound and carbon nanotubes having excellent heat resistance, thereby providing an excellent electrostatic discharge effect as well as excellent high-temperature and high-humidity reliability.

### CROSS-REFERENCE TO RELATED APPLICATIONS

This application claims the priority of Korean Patent Application No. 10-2024-0197139 filed on Dec. 26, 2024, in the Korean Intellectual Property Office, the disclosure of which is incorporated herein by reference.

### BACKGROUND

### Technical Field

The present disclosure relates to a display device, and more particularly, to a display device including an antistatic film having excellent durability in high temperature and high humidity environments, thereby improving reliability of the display device and exhibiting excellent optical characteristics.

### Description of the Related Art

With the advent of the recent information age, the field of displays for visually representing electrical information signals has rapidly developed, and in response thereto, various types of display devices having excellent performance such as thinness, light weight, and low power consumption have been developed. Specific examples of such display devices include a liquid crystal display (LCD) device, a plasma display panel (PDP) device, a field emission display (FED) device, and an organic light emitting display (OLED) device.

In general, a liquid crystal display device is a device in which two substrates, each having an electrode formed on one surface, are disposed so that the surfaces on which the electrodes are formed face each other, and a liquid crystal material is interposed between the two substrates. And then, an image is expressed by moving liquid crystal molecules by means of an electric field generated by applying a voltage to the electrodes formed on each substrate, and controlling light transmittance that varies accordingly. At this time, during the manufacturing process of each substrate of the liquid crystal display device, a large amount of static electricity is generated in the course of performing unit processes.

Therefore, in order to discharge such static electricity and to effectively release the accumulated charges when a finished product is formed, indium-tin-oxide (ITO) or indium-zinc-oxide (IZO), which is a transparent conductive material, has been used as an antistatic film on the outer surface of the upper substrate. Although indium-tin-oxide (ITO) or indium-zinc-oxide (IZO) has excellent conductivity due to its low specific resistance and sheet resistance, it is a very expensive transparent conductive metallic material, which becomes a factor in increasing manufacturing costs.

Recently, products such as mobile phones, tablet PCs, and notebook computers, which are portable and equipped with a touch sensor allowing operation by touching the screen, have been released and have attracted great interest from users. Following this trend, various attempts have recently been made to provide touch functionality in liquid crystal display devices, which are used as display elements in various application products. For example, an add-on type liquid crystal display device is prepared by a method of attaching a substrate or panel having a separate touch element formed thereon onto a liquid crystal panel. As another example, an in-cell type liquid crystal display device is prepared by a method in which no separate touch panel is attached onto the display device, and touch electrodes are formed in a display panel unit so that a touch function is embedded therein. Among these, the in-cell type liquid crystal display device has advantages such as product slimness, cost reduction, and light weight, and thus its demand has been increasing recently.

### BRIEF SUMMARY

In an in-cell type liquid crystal display device, when the antistatic film is formed of a transparent conductive metallic material such as indium-tin-oxide (ITO), even if a touch sensor is provided, the conductivity of the antistatic film is greater than the magnitude of the capacitance generated by touch, thereby causing a discharge and thus significantly degrading the touch sensitivity. Therefore, in order to simultaneously secure touch sensitivity and an antistatic effect, the antistatic film must be formed of a material having resistance within a specific range. Accordingly, a method has been proposed in which a polarizing plate having a conductive layer with resistance within a specific range on its top surface is disposed on the display panel. However, in this case, the process steps are complicated, causing problems such as increased manufacturing cost.

Accordingly, a method has been proposed in which an antistatic film is formed between an upper polarizing plate and a display panel using a conductive filler such as carbon nanotubes. However, although carbon nanotubes have excellent high-temperature stability, they are an expensive material, which poses a limitation in reducing manufacturing costs.

An object to be achieved by the present disclosure is to provide a display device including an antistatic film which has an excellent electrostatic discharge effect, while also having excellent high-temperature and high-humidity reliability, at a lower cost compared to the art, by using a low-cost polythiophene-based polymer and a carbon nanotube having relatively superior high-temperature and high-humidity stability.

Another object to be achieved by the present disclosure is to provide a display device having an excellent antistatic effect without degrading touch sensitivity.

Objects of the present disclosure are not limited to the above-mentioned objects, and other objects, which are not mentioned above, can be clearly understood by those skilled in the art from the following descriptions.

A display device according to an exemplary embodiment of the present disclosure includes a display panel, a first polarizing plate disposed below the display panel, a second polarizing plate disposed on the display panel, and an antistatic film disposed between the display panel and the second polarizing plate, in which the antistatic film includes a silicon-based matrix, and a polythiophene-based compound and a carbon nanotube dispersed in the silicon-based matrix, and the carbon nanotube is a water-dispersible carbon nanotube.

Other detailed matters of the exemplary embodiments are included in the detailed description and the drawings.

A display device according to the present disclosure includes, as a conductive material, an antistatic film containing a low-cost polythiophene-based compound and carbon nanotubes having excellent heat resistance, thereby providing an excellent electrostatic discharge effect as well as excellent high-temperature and high-humidity reliability.

In addition, according to the present disclosure, there is an advantage of exhibiting an excellent electrostatic discharge effect without degrading touch sensitivity.

In addition, the display device according to the present disclosure can form an antistatic film between a display panel and an upper polarizing plate through a simple process, thereby simplifying the process and contributing to cost reduction and productivity improvement.

The effects according to the present disclosure are not limited to the contents exemplified above, and more various effects are included in the present specification.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a schematic cross-sectional view of a display device according to an exemplary embodiment of the present disclosure;

FIG. 2 is a schematic cross-sectional view taken along I-I′ of FIG. 1;

FIG. 3 is a graph illustrating the resistance deviation of an antistatic film including Arc CNT/PEDOT:PSS and an antistatic film including CVD CNT/PEDOT:PSS;

FIG. 4 is a graph illustrating the high-temperature reliability evaluation results of examples and reference examples; and

FIG. 5 is a graph illustrating the high-temperature and high-humidity reliability evaluation results of examples and reference examples.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on,” “above,” “below,” and “next,” one or more parts may be positioned between the two parts unless the terms are used with the term “immediately” or “directly.”

When an element or layer is disposed “on” another element or layer, another layer or another element may be interposed directly on the other element or therebetween.

Although the terms “first,” “second,” and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, a display device according to exemplary embodiments of the present disclosure will be described in detail with reference to accompanying drawings.

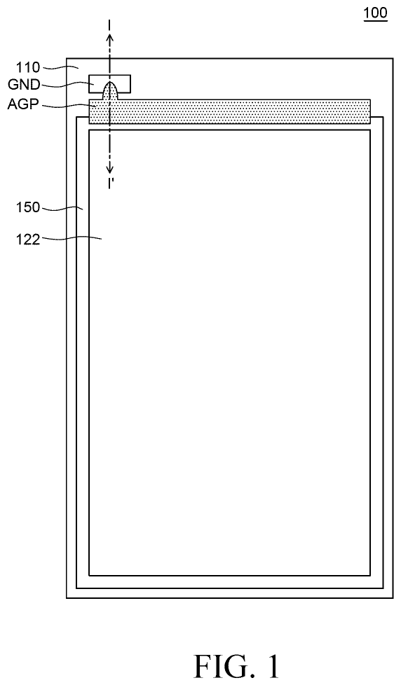

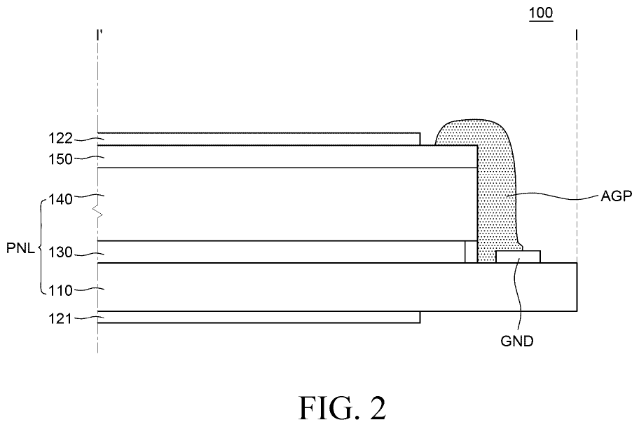

FIG. 1 is a schematic cross-sectional view of a display device according to an exemplary embodiment of the present disclosure. FIG. 2 is a schematic cross-sectional view taken along I-I′ of FIG. 1. Referring to FIGS. 1 and 2, the display device 100 according to an exemplary embodiment of the present disclosure includes a display panel PNL including a lower substrate 110, a liquid crystal layer 130, and an upper substrate 140, a first polarizing plate 121, a second polarizing plate 122, an antistatic film 150, a grounding pad GND, and a conductive member AGP.

The display panel PNL is a panel for displaying an image. For example, the display panel PNL includes a liquid crystal layer, and may be a liquid crystal display panel that displays an image by controlling light transmittance of a liquid crystal. Hereinafter, it will be assumed that the display panel PNL is a liquid crystal display panel, and a display device 100 according to an exemplary embodiment of the present disclosure will be described in detail, but the display panel PNL is not limited to the liquid crystal display panel.

The display panel PNL includes areas defined as an active area and a non-active area. The active area is an area in which a plurality of pixels is disposed and thus an image is substantially displayed. The active area is provided with pixels including an emissive area for displaying an image, and driving elements such as driving thin film transistors for driving the pixels. The non-active area is an area substantially not displaying an image due to being covered by a light shielding member or the like. Various wiring lines, printed circuit boards, and the like for driving the pixels and driving elements disposed in the active area are disposed in the non-active area.

A backlight unit may be disposed on the rear surface of the display panel PNL. The backlight unit is a light source that supplies light to the liquid crystal display panel. For example, the backlight unit may be an edge-type backlight unit or a direct-type backlight unit.

The display panel PNL may be an in-cell touch type display panel having a built-in touch sensor. Hereinafter, for convenience of explanation, the display panel PNL will be described on the assumption that it is an in-cell touch type display panel. However, this is merely an example, and the display panel PNL of the present disclosure is not limited to the in-cell touch type display panel.

The lower substrate 110 is a thin film transistor array substrate provided with a plurality of pixels and thin film transistors for driving each of the pixels. On the lower substrate 110, a plurality of gate lines and a plurality of data lines are formed to intersect with each other so as to define a plurality of pixel areas. A thin film transistor for driving a pixel is provided at each intersection of the plurality of gate lines and the plurality of data lines.

Each thin film transistor is connected to a pixel electrode formed in each pixel, and thus supplies a data voltage provided through the data lines to each pixel in response to a scan signal applied through the gate lines.

A common electrode forms an electric field with the pixel electrode to control liquid crystals. The liquid crystal layer 130 is driven by controlling an arrangement of liquid crystals through the electric field formed according to a data voltage and a common voltage applied through the data lines.

Each of the common electrode and the pixel electrode may be formed of a transparent conductive material such as indium-tin-oxide (ITO) or indium-zinc-oxide (IZO).

The lower substrate 110 includes a touch sensor for detecting a touch by sensing capacitance according to a user's touch. For example, the touch sensor may include a plurality of driving electrodes to which a touch driving signal is supplied, and a plurality of sensing electrodes for sensing a touch signal. A touch driver is disposed on the lower substrate 110 corresponding to the non-active area. The touch driver may include a touch driving IC and a touch sensing IC. The touch driving IC supplies a touch driving signal to the plurality of touch driving electrodes through the driving electrode lines. The touch sensing IC is connected to the plurality of sensing electrodes through the touch sensing electrode lines to sense a touch signal.

In the in-cell touch type display panel, the common electrode formed to supply a common voltage to the pixels may be patterned to be used as the driving electrodes and the sensing electrodes.

On the lower substrate 110 corresponding to the non-active area, a grounding pad GND for grounding charges formed by static electricity may be disposed. The grounding pad GND discharges charges accumulated by static electricity. The grounding pad GND is electrically connected to the antistatic film 150 by means of the conductive member AGP, which will be described later.

The upper substrate 140 is a color filter array substrate including a color filter and a black matrix. The color filter selectively transmits light of a specific wavelength. Accordingly, light emitted from the backlight unit passes through the liquid crystal layer 130 between the lower substrate 110 and the upper substrate 140 and the color filter, and is converted into light of various colors. For example, the color filter includes red, green, and blue color filters, and the red, green, and blue color filters are disposed to correspond to colors displayed by each pixel. The black matrix is formed to correspond to boundaries of each pixel to partition the pixels and suppress color mixing. In addition, the black matrix may cover the gate lines, data lines, or thin film transistors disposed on the lower substrate 110 so as not to be visible.

The liquid crystal layer 130 is disposed between the lower substrate 110 and the upper substrate 140. The liquid crystal layer 130 may be disposed above the thin film transistors and the touch sensor provided in the lower substrate 110. The liquid crystal layer 130 includes a liquid crystal material such as liquid crystal molecules or liquid crystal polymers. The transmittance of light generated from the backlight unit may be controlled by controlling the arrangement of the liquid crystal material by means of an electric field applied to the liquid crystal layer 130.

Below the display panel PNL, a first polarizing plate 121 is disposed. The first polarizing plate 121 is attached to the bottom surface of the lower substrate 110 to overlap the active area. A second polarizing plate 122 is disposed above the display panel PNL. The second polarizing plate 122 is disposed on the upper substrate 140 to overlap the active area. Specifically, the second polarizing plate 122 may be attached on the antistatic film 150 described later.

For example, each of the first polarizing plate 121 and the second polarizing plate 122 may be formed by stretching polyvinyl alcohol dyed with iodine (I), but is not limited thereto. Each of the first polarizing plate 121 and the second polarizing plate 122 has an absorption axis formed in the stretching direction so that light vibrating in a direction parallel to the absorption axis is absorbed, and only light vibrating in a direction perpendicular to the absorption axis is selectively transmitted. Accordingly, the optical characteristics and display quality of the display device 100 may be further improved.

The antistatic film 150 is disposed above the display panel PNL. The antistatic film 150 minimizes damage and touch detection errors caused by charge accumulation generated due to static electricity generated during manufacturing and use of the display device 100. The antistatic film 150 is disposed on the top surface of the upper substrate 140. The antistatic film 150 is formed to be in direct contact with the top surface of the upper substrate 140. When the antistatic film 150 is formed to be in direct contact with the top surface of the upper substrate 140, compared to a conventional structure in which the antistatic film is formed on the top surface of the second polarizing plate, the manufacturing process can be simplified to improve productivity and reduce manufacturing costs.

Specifically, when the antistatic film is formed on the top surface of the second polarizing plate, the second polarizing plate having the antistatic film formed thereon is attached to the display panel, and then a connecting member such as conductive tape is attached to connect one end of the antistatic film to the grounding pad. Thereafter, a conductive member is dotted at a contact area between one end of the connecting member and the antistatic film and a contact area between the other end of the connecting member and the grounding pad to allow electrical connection. In contrast, as illustrated in FIG. 2, when the antistatic film 150 is directly disposed on the upper substrate 140, a connecting member for connecting the antistatic film 150 and the grounding pad GND is not required, and an electrical connection between the antistatic film 150 and the grounding pad GND may be achieved simply by dotting the conductive member AGP in a single process without dotting the conductive member at both ends of the connecting member. Accordingly, process efficiency is improved and costs may be reduced.

Hereinafter, a connection structure between the antistatic film 150 and the grounding pad GND in the display device 100 according to an exemplary embodiment of the present disclosure will be described in detail.

Each of the lower substrate 110 and the upper substrate 140 may extend further outward than the first polarizing plate 121 and the second polarizing plate 122. One end of the lower substrate 110 and the upper substrate 140 extends further outward than one end of each of the first polarizing plate 121 and the second polarizing plate 122.

One end of the lower substrate 110 may extend further outward than one end of the upper substrate 140. The grounding pad GND is disposed on the lower substrate 110 exposed without being covered by the upper substrate 140.

As described above, the antistatic film 150 is directly disposed on the upper substrate 140. Accordingly, to correspond to the upper substrate 140, one end of the antistatic film 150 may extend further outward than one end of the second polarizing plate 122.

The conductive member AGP is disposed to electrically connect the top surface of the antistatic film 150 exposed without being covered by the second polarizing plate 122 and the grounding pad GND. The conductive member AGP extends outward beyond the second polarizing plate 122 to be in direct contact with the top surface of the antistatic film 150 exposed without being covered by the second polarizing plate 122, the side surface of the antistatic film 150, the side surface of the upper substrate 140, and the top surface of the grounding pad GND. In this way, the antistatic film 150 is connected to the grounding pad GND by the conductive member AGP so that charges accumulated by static electricity generated in the display device 100 may be discharged to the outside.

For example, the conductive member AGP may be formed of a metallic material selected from gold, silver, copper and the like. For example, the conductive member AGP may be formed by dotting a conductive paste including an adhesive binder resin and silver (Ag), but is not limited thereto.

Hereinafter, the antistatic film 150 will be described in detail. The antistatic film 150 includes a silicon-based matrix, a polythiophene-based compound, and a carbon nanotube. The polythiophene-based compound and the carbon nanotube are dispersed in the silicon-based matrix.

The silicon-based matrix uniformly disperses the polythiophene-based compound and the carbon nanotube. The silicon-based matrix may be a transparent conductive film having a network structure formed of a cross-linkable compound. In addition, the silicon-based matrix imparts heat resistance and moisture resistance to the antistatic film 150.

The silicon-based matrix may be formed by curing a composition including one or more of tetraalkyl orthosilicate and silsesquioxane. For example, the silicon-based matrix may be formed by curing a composition including tetraalkyl orthosilicate. Tetraalkyl orthosilicate has excellent reactivity and exhibits superior adhesion to the upper substrate 140 serving as the base.

Specifically, for example, the silicon-based matrix may be formed from a composition including tetraalkyl orthosilicate, an acid catalyst, an alcohol-based solvent, water, and the like. The tetraalkyl orthosilicate compound forms silanol through hydrolysis in the presence of water, the acid catalyst, and the alcohol-based solvent, and the silanol is polymerized and crosslinked through a condensation reaction to form the silicon-based matrix.

For example, tetraalkyl orthosilicate may be selected from tetraethyl orthosilicate, tetramethyl orthosilicate, tetra-n-propyl orthosilicate, and the like, but is not limited thereto.

Water is added for the hydrolysis of the tetraalkyl orthosilicate compound. The acid catalyst increases the solubility of the tetraalkyl orthosilicate compound, adjusts the reaction pH, and thus promotes the hydrolysis of the tetraalkyl orthosilicate compound with water.

For example, the acid catalyst may be selected from hydrochloric acid, sulfuric acid, phosphoric acid, nitric acid, acetic acid, and the like, but is not limited thereto.

The alcohol-based solvent serves as a reaction medium to uniformly disperse the tetraalkyl orthosilicate. The polythiophene-based compound and the carbon nanotube, which are used as conductive materials in the present disclosure, have water-dispersible characteristics, and thus, an alcohol-based solvent having hydrophilicity is used as the solvent. For example, the alcohol-based solvent may be selected from methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, cyclohexanol, and the like.

The composition for forming the silicon-based matrix may further include, if necessary, an alkylene glycol-based solvent, selectively. For example, the alkylene glycol-based solvent may further include a solvent such as ethylene glycol, triethylene glycol, polyethylene glycol, propylene glycol, dipropylene glycol, dihexylene glycol, propylene glycol methyl ether (PGME), diethylene glycol butyl ether, diethylene glycol ethyl ether, dipropylene glycol methyl ether, and dihexylene glycol ethyl ether. By using the alcohol-based solvent and the alkylene glycol-based solvent in this way, the reaction of the tetraalkyl orthosilicate compound may be further facilitated.

The silicon-based matrix may be formed to further include a random-type silsesquioxane compound, a cage-type silsesquioxane compound, or both. When the random-type silsesquioxane compound and/or the cage-type silsesquioxane compound is/are further included, the density and hardness of the antistatic film 150 are further improved, thereby providing an advantage of excellent reliability.

The random-type silsesquioxane compound and/or the cage-type silsesquioxane compound is/are added to the composition for forming the silicon-based matrix. The alkoxysilane-based compound is hydrolyzed by water and the acid catalyst to form silanol, and the silanol may be bonded by reacting with an —OH group of the silsesquioxane compound.

The polythiophene-based compound and the carbon nanotube are dispersed in the silicon-based matrix.

First, the polythiophene-based compound, which is a conductive polymer, may effectively discharge static electricity while allowing to maintain high touch sensitivity without its degradation. Conventional materials such as indium-tin-oxide (ITO), which is a transparent conductive metallic material used as an antistatic film, have a surface resistance that is too low and thus discharge charges accumulated by touch. As a result, a change in capacitance generated by the touch cannot be accurately detected, causing a problem of reduced touch sensitivity. In addition, the polythiophene-based compound has the advantage of low cost. Accordingly, when the polythiophene-based compound is used as a conductive material of the antistatic film 150, the transmittance of the antistatic film 150 is improved, thereby providing excellent optical characteristics of the display device 100 and reducing manufacturing cost.

For example, the polythiophene-based compound may be poly(3,4-ethylenedioxythiophene):poly(styrenesulfonate) [PEDOT:PSS]. The polythiophene-based compound has excellent electrical conductivity and is advantageous for suppressing static electricity. If necessary, selectively, conductive polymers selected from polyaniline, polyacetylene, polypyrrole, polythiophene, and polysulfur nitride may be further included as conductive materials.

The poly(3,4-ethylenedioxythiophene):poly(styrenesulfonate) [PEDOT:PSS] is a conductive polymer composed mainly of poly(3,4-ethylenedioxythiophene) and doped with poly(styrenesulfonate). The poly(styrenesulfonate) includes a sulfonic acid group, which becomes negatively charged by dehydrogenation in a solvent, while the PEDOT portion becomes positively charged. Therefore, the PEDOT:PSS may be formed in a stable salt form and has good dispersibility in hydrophilic solvents.

For example, the weight ratio of poly(3,4-ethylenedioxythiophene) to the poly(styrenesulfonate) may be 1:4 to 1:7, and more preferably 1:4.5 to 1:5.5. Within this range, high-temperature reliability and high-temperature/high-humidity reliability are excellent, and particularly, when the weight ratio is 1:4.5 to 1:5.5, the reliability is further improved.

The polythiophene-based compound may be added to the above-described composition for forming the silicon-based matrix, and, if necessary, selectively, a separate aqueous polythiophene-based solution may be prepared and then mixed with the composition for forming the silicon-based matrix.

The polythiophene-based compounds have a strong tendency to become entangled with each other due to interchain interactions. Therefore, the PEDOT:PSS in the formed of the polythiophene doped with poly(styrenesulfonate) is used. However, even when introduced in the form of PEDOT:PSS, chain entanglement occurs at high temperature, leading to a problem of reduced high-temperature reliability. Specifically, an antistatic film containing a polythiophene-based compound exhibits a phenomenon in which, during reliability evaluation under high-humidity conditions, a water film is initially formed due to moisture, causing a rapid drop in resistance. However, after a critical time, swelling and decomposition of the polymer due to moisture cause resistance to continuously increase, thereby degrading electrical properties.

Accordingly, for the present disclosure, a carbon nanotube is applied as a conductive material in combination. The carbon nanotube has better high-temperature stability than the polythiophene-based compound, and thus has excellent high-temperature and high-humidity reliability. In this case, the carbon nanotube may be a water-dispersible carbon nanotube. Since the polythiophene-based compound has excellent dispersibility in hydrophilic solvents, it is preferable that the carbon nanotube also has water-dispersibility so as to be uniformly mixed with the polythiophene-based compound.

In this case, the carbon nanotube may be a single-walled carbon nanotube (SWCNT). Compared to multi-walled carbon nanotubes (MWCNTs), the single-walled carbon nanotube has advantages of superior antistatic properties and higher light transmittance.

In general, carbon nanotubes have strong aggregation properties, making it difficult to achieve uniform dispersion. Therefore, in the present disclosure, a single-walled carbon nanotube obtained by a chemical vapor deposition method is used. A single-walled carbon nanotube obtained by a chemical vapor deposition method is easily dispersible in a solution and thus has the advantage of uniform antistatic properties. The water-dispersible carbon nanotube forms bundles during water dispersion, and the bundle size of the carbon nanotube obtained by the chemical vapor deposition method is larger than that of the carbon nanotube obtained by an arc discharge method. Therefore, the carbon nanotube obtained by the chemical vapor deposition method has a lower aggregation force than that obtained by the arc discharge method.

For example, the water-dispersible carbon nanotube may be a single-walled carbon nanotube having an average diameter of 2.0 nm to 4.0 nm. Within this range, the carbon nanotube has low aggregation force, providing the advantage of easy water dispersion. When the average diameter of the water-dispersible carbon nanotube is less than 2.0 nm, the aggregation force between particles increases, making it difficult to uniformly disperse the carbon nanotubes in the solution, which may increase property variations of the antistatic film. On the other hand, when the average diameter of the water-dispersible carbon nanotube exceeds 4.0 nm, the resistance may increase, leading to deterioration in electrical properties.

For example, the water-dispersible carbon nanotube may form bundles during water dispersion, and the average particle diameter D90 of the bundles may be 90 nm to 120 nm. The D90 refers to the particle diameter at which the cumulative percentage reaches 90% in a particle size distribution graph of the carbon nanotube, and, for example, the D90 may be measured using a particle size analyzer (ELSZ-2000) manufactured by Otsuka Electronics Co., Ltd. When the average particle diameter D90 of the water-dispersible carbon nanotube is within the above range, the aggregation force of the carbon nanotube is low, enabling uniform dispersion during water dispersion. Accordingly, the antistatic film 150 has uniform resistance characteristics, which is advantageous. When the average particle diameter (D90) of the water-dispersible carbon nanotube bundles exceeds 120 nm, the dispersibility may deteriorate, leading to poor electrical properties.

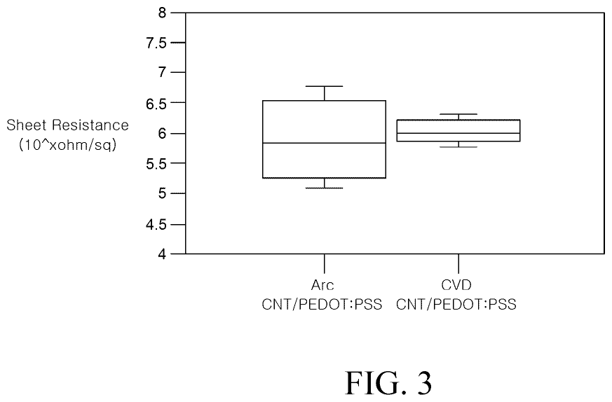

This will now be described in detail with reference to FIG. 3. FIG. 3 is a graph illustrating the resistance variation by the positions of a sample (370 cm×470 cm) to which a single-walled carbon nanotube manufactured by arc discharge and PEDOT:PSS are mixed and a sample (370 cm×470 cm) to which a single-walled carbon nanotube manufactured by a chemical vapor deposition method and PEDOT:PSS is mixed.

First, it was confirmed through TEM analysis that the single-walled carbon nanotube manufactured by arc discharge has a particle diameter of 1.35 nm to 1.7 nm, with an average particle diameter of about 1.5 nm. In contrast, the single-walled carbon nanotube manufactured by a chemical vapor deposition method has a particle diameter of about 1.84 nm to 3.23 nm, with an average particle diameter of about 2.2 nm, which is larger than that of the carbon nanotube manufactured by arc discharge. Since the single-walled carbon nanotube manufactured by a chemical vapor deposition method has a larger average particle diameter, the bundle size formed in an aqueous solution is smaller than that of single-walled carbon nanotubes manufactured by arc discharge. For example, in the case of the arc-discharge carbon nanotube having an average particle diameter of 1.5 nm, the average bundle size D90 upon water dispersion is 143 nm, whereas in the case of the chemical vapor deposition carbon nanotube having an average particle diameter of about 2.2 nm, the average bundle size D90 upon water dispersion is 100 nm, which is smaller.

Accordingly, in the present disclosure, in the case of the single-walled carbon nanotube manufactured by a chemical vapor deposition method, the aggregation force during water dispersion is low, resulting in a smaller bundle size and excellent dispersibility. Furthermore, referring to FIG. 3, it can be confirmed that the resistance variation of the surface resistance of the CVD/PEDOT:PSS antistatic film including the carbon nanotube manufactured by a chemical vapor deposition method is much smaller than that of the Arc CNT/PEDOT:PSS antistatic film including the carbon nanotube manufactured by arc discharge. Specifically, it is confirmed that the sheet resistance of the CVD/PEDOT:PSS antistatic film is 10^{5.9} to 10^{6.3} Ω/sq, whereas the Arc CNT/PEDOT:PSS antistatic film shows a larger variation of 10^{5.1} to 10^{6.8} Ω/sq.

The present disclosure may provide the antistatic film 150 in which a low-cost material, the polythiophene-based compound, and a water-dispersible carbon nanotube having excellent high-temperature and high-humidity reliability are mixed as conductive materials, thereby improving reliability while reducing cost.

For example, the weight ratio of the carbon nanotube to the polythiophene-based compound dispersed in the silicon-based matrix may be 1:1000 to 1:50 or 1:500 to 1:100, and preferably 5:950 to 2:980. Within this range, the antistatic film exhibits the advantage of excellent high-temperature and high-humidity reliability.

The antistatic film 150 may be formed by applying, onto the upper substrate 140, an antistatic film coating solution obtained by adding a polythiophene-based compound and an aqueous carbon nanotube solution to a composition for forming a silicon-based matrix including one or more of tetraalkyl orthosilicate and silsesquioxane, an acid catalyst, an alcohol-based solvent, and water, and curing the coating.

The polythiophene-based compound may be directly mixed into the composition or mixed in the form of an aqueous solution.

The water-dispersible carbon nanotube may be mixed into the composition for forming the silicon-based matrix in an aqueous solution state to increase dispersibility. In this case, a dispersant may be added to increase the dispersibility of the water-dispersible carbon nanotube. For example, the dispersant may be selected from polycarboxylate-based superplasticizer, sodium dodecyl sulfate (SDS), sodium dodecyl benzene sulfonate (SDBS), polyvinylpyrrolidone (PVP), sodium deoxycholate (DOC), and the like. When such a dispersant is introduced, dispersion stability in the composition for forming the silicon-based matrix may be improved.

For example, the aqueous solution of the water-dispersible carbon nanotube may include 0.05 wt % to 0.15 wt % of the single-walled carbon nanotube, 0.5 wt % to 2.0 wt % of the dispersant, and the remaining amount of water.

For example, the composition for forming the silicon-based matrix, to which the aqueous solution of the water-dispersible carbon nanotube and the polythiophene-based compound are added, may include 50 wt % to 80 wt % of water, 5 wt % to 15 wt % of an alkylene glycol-based solvent, 2 wt % to 40 wt % of an alcohol-based solvent, 5 wt % to 15 wt % of tetraalkyl orthosilicate, 0.001 wt % to 1 wt % of the acid catalyst, 0.001 wt % to 1 wt % of the polythiophene-based compound, and 0.001 wt % to 2 wt % of the water-dispersible carbon nanotube.

The composition may optionally further include additives such as a leveling agent, a silane coupling agent, a dispersion stabilizer, an antioxidant, a surfactant, or the like, if necessary.

The antistatic film 150 may be formed by applying the composition prepared as described above onto the upper substrate 140 and curing it. For example, the composition for forming the antistatic film may be applied onto the upper substrate 140 by a known method such as a slit coating method, a knife coating method, a spin coating method, a casting method, a microgravure coating method, a gravure coating method, a bar coating method, a roll coating method, a wire bar coating method, a dip coating method, a spray coating method, a screen printing method, a gravure printing method, a flexographic printing method, an offset printing method, an inkjet coating method, a dispenser printing method, a nozzle coating method, a capillary coating method, or the like. After applying, the antistatic film 150 may be formed by heating the coated film to a predetermined temperature and curing it. For example, the surface resistivity of the antistatic film 150 at room temperature may be 1.0×10⁵ Ω/sq to 9.0×10⁶ Ω/sq. Accordingly, the display device 100 according to an exemplary embodiment of the present disclosure may provide advantages of excellent touch sensitivity and excellent electrostatic discharge characteristics. When the resistance of the antistatic film 150 is too small, a voltage generated when the user touches the display device 100 may be discharged due to the antistatic film 150, thereby significantly reducing touch sensitivity. When the resistance of the antistatic film 150 is too large, although the touch sensitivity is excellent, static electricity generated during the manufacturing process of the display device 100 or during the use of the display device 100 may be discharged too slowly or may not be discharged.

The antistatic film 150 according to an exemplary embodiment of the present disclosure is prepared by using the relatively low-cost polythiophene-based compound and the water-dispersible carbon nanotube having excellent reliability under high-temperature and high-humidity environments in combination, thereby significantly reducing the manufacturing cost of the display device and also providing excellent electrical properties. In addition, the water-dispersible carbon nanotube is applied in combination to compensate for the poor heat resistance and moisture resistance of the polythiophene-based compound, so that high electrical properties can be maintained for a long period of time during high-temperature and high-humidity reliability evaluation. For example, for the antistatic film 150, the difference between the maximum value and the minimum value of the surface resistivity measured after being stored for 1000 hours under high-temperature conditions of 60° C. and high-humidity conditions of 90% relative humidity may be 1.0 or less, so that the resistance value may be stably maintained under high-temperature and high-humidity conditions.

Hereinafter, the effects of the present disclosure described above will be described in more detail through exemplary embodiments. However, the following exemplary embodiments are provided for illustration of the present disclosure, and the scope of the present disclosure is not limited thereto.

### Examples 1-1 to 1-4, Comparative Example 1, Reference Examples 1-1 to 1-2

First, a water-dispersible single-walled carbon nanotube having an average diameter of 2.0 nm to 4.0 nm and an average bundle particle diameter D90 of about 100 nm in an aqueous solution state, manufactured by a chemical vapor deposition method, was prepared. Water, a dispersant, and the water-dispersible single-walled carbon nanotube were mixed in the amounts shown in Table 1 below, and stirred to prepare a single-walled carbon nanotube dispersion.

Next, 5 to 15 wt % of tetraethyl orthosilicate (TEOS), 50 to 80 wt % of water, 5 to 15 wt % of PGME, 0.001 to 1 wt % of PEDOT:PSS, 1 to 20 wt % of n-propanol, 1 to 20 wt % of IPA, and 0.001 to 1 wt % of acetic acid were mixed and stirred to prepare a PEDOT:PSS coating solution. The single-walled carbon nanotube dispersion prepared above was mixed and stirred at the ratios shown in Table 1 below. Then, the prepared coating solution was spin-coated (400 rpm, 15 seconds) on a glass substrate, heated at 140° C. for 10 minutes, and dried using a hot-air dryer for 30 minutes to form an antistatic film.

TABLE 1

| | SWCNT Dispersion | | | | | Solution mixing ratio | |
|---|---|---|---|---|---|---|---|
| | SWCNT | Dispersant | | Water | | SWCNT | PEDOT:PSS |
| | Content | | Content | Content | Total | Dispersion | Coating solution |
| Classification | (wt %) | Type | (wt %) | (wt %) | (wt %) | (wt %) | (wt %) |
| Example 1-1 | 0.1 | SDBS | 1 | 98.9 | 100 | 5 | 95 |
| Example 1-2 | 0.1 | SDBS | 1 | 98.9 | 100 | 2 | 98 |
| Example 1-3 | 0.1 | SDS | 1.5 | 98.4 | 100 | 5 | 95 |
| Example 1-4 | 0.1 | SDS | 1.5 | 98.4 | 100 | 2 | 98 |
| Comparative | — | — | — | — | — | 0 | 100 |
| Example 1 | | | | | | | |
| Reference | 0.1 | SDBS | 1 | 98.9 | 100 | 7 | 93 |
| Example 1-1 | | | | | | | |
| Reference | 0.1 | SDS | 1 | 98.9 | 100 | 7 | 93 |
| Example 1-2 | | | | | | | |

The dispersibility and coatability of the coating solution, and the transmittance and surface resistivity of the antistatic film according to Examples 1-1 to 1-4, Comparative Example 1, and Reference Examples 1-1 to 1-2 were measured. Dispersibility was evaluated as “O” when no precipitate was generated within 30 days while storing the coating solution at −20° C., “A” when no precipitate was generated within 10 days, and “X” when precipitate was generated within 10 days. Coatability was evaluated as “O” when the number of particles of 1 μm or more was one or less after coating the coating solution on a substrate of 30 cm×30 cm size, “A” when the number of particles of 1 μm or more was 2 to 5, and “X” when the number of particles of 1 μm or more was 6 or more. Transmittance was measured with a spectrophotometer. For evaluating surface resistivity, the surface resistivity was measured at room temperature immediately after sample preparation, and then measured again after storage for 1000 hours under a high-temperature condition of 95° C. to determine high-temperature reliability. The surface resistivity was measured using a surface resistance meter (ST-4) of SYMCO JAPAN. The results are shown in Table 2 below.

TABLE 2

| | | | Transmittance | Surface resistivity (Ω/sq) | |
|---|---|---|---|---|---|
| | | | Measured value | Room | High temperature |
| Classification | Dispersibility | Coatability | (%) | temperature | (95° C., 1000 Hr) |
| Example 1-1 | ◯ | ◯ | 99.0 | 9.0 × 10⁵ | 7.0 × 10⁶ |
| Example 1-2 | ◯ | ◯ | 99.6 | 1.0 × 10⁶ | 1.0 × 10⁷ |
| Example 1-3 | ◯ | ◯ | 98.9 | 1.0 × 10⁶ | 2.0 × 10⁷ |
| Example 1-4 | ◯ | ◯ | 99.4 | 7.0 × 10⁶ | 9.0 × 10⁷ |
| Comparative | ◯ | ◯ | 99.5 | 7.0 × 10⁵ | 2.0 × 10⁹ |
| Example 1 | | | | | |
| Reference | X | Δ | 97.5 | 5.0 × 10⁷ | 9.0 × 10⁸ |
| Example 1-1 | | | | | |
| Reference | X | X | 97.2 | 1.0 × 10⁸ | 3.0 × 10⁹ |
| Example 1-2 | | | | | |

Referring to Table 2, in the cases of Examples 1-1 to 1-4 in which a single-walled carbon nanotube obtained by a chemical vapor deposition method and PEDOT:PSS were mixed and applied, all of the dispersibility, coatability, transmittance, and surface resistivities at room temperature and at high-temperature were superior to those of Reference Examples 1-1 and 1-2. Accordingly, it can be seen that when the single-walled carbon nanotube and PEDOT:PSS are mixed and applied, the physical properties vary depending on the mixing ratio of the carbon nanotube dispersion to the conductive polymer coating solution, and that when the mixing ratio of the carbon nanotube dispersion to the conductive polymer coating solution is 2:98 to 5:95 by weight, the effect is more advantageous.

In the case of Comparative Example 1 in which the single-walled carbon nanotube obtained by a chemical vapor deposition method was not mixed and applied, the dispersibility, coatability, and transmittance were good, but it was confirmed that the resistance value increased the most during high-temperature storage, indicating that high-temperature reliability was significantly inferior.

In addition, when comparing Example 1-1 with Example 1-3 or Example 1-2 with Example 1-4, it was confirmed that when SDBS was used as a dispersant, the transmittance was higher and the surface resistivity was higher than when SDS was used as a dispersant.

### Experimental Example 2

Antistatic film samples were prepared by varying the mixing ratio of the carbon nanotube and PEDOT:PSS, and the mixing ratio between PEDOT and PSS, as shown in Table 3 below, and the change in sheet resistance over time was analyzed.

TABLE 3

| | CNT-to-PEDOT:PSS | | PEDOT-to-PSS | |
|---|---|---|---|---|
| | content ratio | | content ratio | |
| Classification | CNT | PEDOT:PSS | PEDOT | PSS |
| Comparative Example 1 | — | 100 | 1 | 5 |
| Comparative Example 2 | 100 | — | — | — |
| Example 2-1 | 5 | 95 | 1 | 5 |
| Example 2-2 | 2 | 98 | 1 | 5 |
| Reference Example 2-1 | 7 | 93 | 1 | 5 |
| Reference Example 2-2 | 5 | 95 | 1 | 7 |
| Reference Example 2-3 | 5 | 95 | 1 | 6 |
| Reference Example 2-4 | 5 | 95 | 1 | 4 |

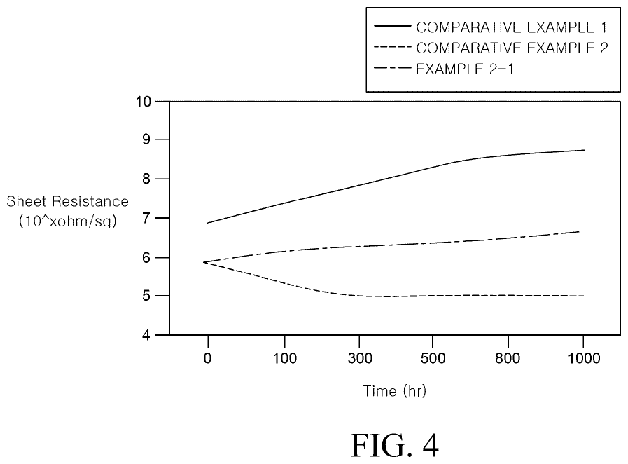

For each of the samples listed in Table 3, the change in sheet resistance over time under high-temperature conditions was analyzed. First, in order to evaluate high-temperature reliability, each sample listed in Table 3 was stored at 105° C. for 1000 hours, and the surface resistivity were measured at regular time intervals. The difference between the initial resistance and the resistance after 1000 hours was then calculated. The results are shown in Table 4 and FIG. 4. FIG. 4 is a graph illustrating the results of the high-temperature reliability evaluation for the examples and reference examples.

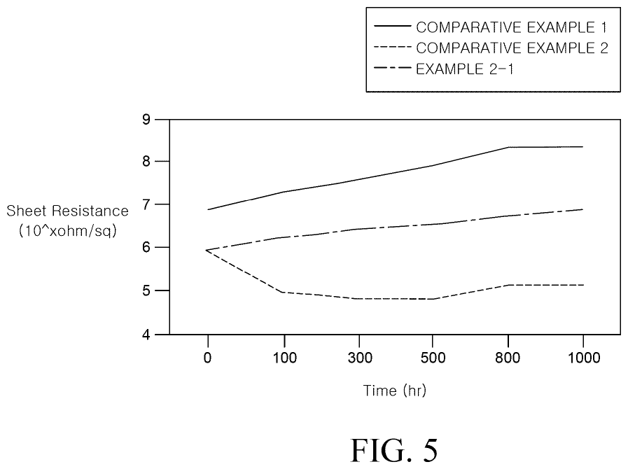

In addition, for each of the samples listed in Table 3, the change in sheet resistance over time under high-temperature and high-humidity conditions was analyzed. First, to evaluate high-temperature and high-humidity reliability, each sample listed in Table 3 was stored at 60° C. and 90% relative humidity for 1000 hours, and the surface resistivity were measured at regular time intervals. The difference between the initial resistance and the resistance after 1000 hours was then calculated. The results are shown in Table 5 and FIG. 5. FIG. 5 is a graph illustrating the results of the high-temperature and high-humidity reliability evaluation for the examples and reference examples.

TABLE 4

| | Sheet resistance over elapsed time | | | | | | |
|---|---|---|---|---|---|---|---|
| | 0 | 150 | 300 | 500 | 750 | 1000 | Δ Sheet |
| 105° C. | hr | hr | hr | hr | hr | hr | resistance |
| Comparative | 6.9 | 7.4 | 7.8 | 8.3 | 8.6 | 8.7 | 1.8 |
| Example 1 | | | | | | | |
| Comparative | 5.9 | 5.30 | 5.00 | 5.0 | 5.0 | 5 | −0.95 |
| Example 2 | | | | | | | |
| Example 2-1 | 5.90 | 6.17 | 6.30 | 6.40 | 6.50 | 6.72 | 0.82 |
| Example 2-2 | 6.48 | 6.84 | 7.00 | 7.10 | 7.13 | 7.42 | 0.94 |
| Reference | 8.30 | 9.00 | 9.00 | 9.10 | 9.30 | 9.60 | 1.30 |
| Example 2-1 | | | | | | | |
| Reference | 8.95 | 9.48 | 9.48 | 9.53 | 9.73 | 9.97 | 1.02 |
| Example 2-2 | | | | | | | |
| Reference | 6.70 | 7.30 | 7.30 | 7.50 | 7.60 | 7.85 | 1.15 |
| Example 2-3 | | | | | | | |
| Reference | 5.5 | 6.08 | 6.08 | 6.39 | 6.6 | 6.9 | 1.40 |
| Example 2-4 | | | | | | | |

### Unit of Surface Resistivity: Ω/Sq

Referring to Table 4 and FIG. 4 together, it can be seen that in the case of Comparative Example 1 in which only PEDOT:PSS was applied, the change in sheet resistance after 1000 hours was the largest. It can be seen that in the case of Comparative Example 2 in which only CNT was applied, the change in sheet resistance was relatively small at 0.95. From this, it can be seen that PEDOT:PSS has relatively poor heat resistance, while CNT has excellent heat resistance. Meanwhile, in the cases of Examples 2-1 and 2-2 in which PEDOT:PSS and CNT were mixed and applied in a specific ratio, it was confirmed that the initial sheet resistance was low, providing good electrical characteristics, and the change in sheet resistance after 1000 hours had a heat resistance similar to that of Comparative Example 2 in which only CNT was applied.

When comparing Examples 2-1, 2-2, and Reference Example 2-1 in which the ratio of PEDOT-to-PSS is the same at 1:5, it was confirmed that Example 2-1 having a CNT-to-PEDOT:PSS ratio of 5:95 had the best high-temperature reliability.

Furthermore, when comparing Examples 2-1, Reference Examples 2-2, 2-3, and 2-4 in which the ratio of CNT-to-PEDOT:PSS is the same at 5:95 but the ratio of PEDOT-to-PSS is different, it was confirmed that Example 2-1 having a PEDOT-to-PSS ratio of 1:5 had the best high-temperature reliability.

TABLE 5

| | Sheet resistance over elapsed time | | | | | | |
|---|---|---|---|---|---|---|---|
| | 0 | 150 | 300 | 500 | 750 | 1000 | Δ sheet |
| 105° C. | hr | hr | hr | hr | hr | hr | resistance |
| Comparative | 6.9 | 7.3 | 7.6 | 7.9 | 8.3 | 8.3 | 1.4 |
| Example 1 | | | | | | | |
| Comparative | 5.9 | 5.0 | 4.8 | 4.8 | 5.1 | 5.1 | −0.85 |
| Example 2 | | | | | | | |
| Example 2-1 | 5.95 | 6.24 | 6.42 | 6.53 | 6.74 | 6.87 | 0.92 |
| Example 2-2 | 6.48 | 6.77 | 6.92 | 7.13 | 7.22 | 7.41 | 0.93 |
| Reference | 8.30 | 9.00 | 9.10 | 9.48 | 9.59 | 10.30 | 2.00 |
| Example 2-1 | | | | | | | |
| Reference | 8.85 | 9.48 | 9.60 | 9.67 | 9.93 | 10.12 | 1.27 |
| Example 2-2 | | | | | | | |
| Reference | 6.70 | 7.30 | 7.30 | 7.60 | 7.90 | 8.11 | 1.41 |
| Example 2-3 | | | | | | | |
| Reference | 5.3 | 5.9 | 6.08 | 6.24 | 6.32 | 6.83 | 1.53 |
| Example 2-4 | | | | | | | |

### Unit of Surface Resistivity: Ω/Sq

Referring to Table 5 and FIG. 5 together, it can be seen that in the case of Comparative Example 1 in which only PEDOT:PSS was applied, the change in sheet resistance after 1000 hours was 1.4, and in the case of Comparative Example 2 in which only CNT was applied, the change in sheet resistance was 0.85, which was much smaller than that of Comparative Example 1. From this, it can be seen that PEDOT:PSS has relatively poor heat resistance, while CNT has excellent heat resistance.

Meanwhile, it was confirmed that in the cases of Examples 2-1 and 2-2 in which PEDOT:PSS and CNT were mixed and applied in a specific ratio, the initial sheet resistance was similar to that in the cases where CNT or PEDOT:PSS was used alone. However, it was confirmed that the change in sheet resistance after 1000 hours in Examples 2-1 and 2-2 was much smaller than that of Comparative Example 1 in which only PEDOT:PSS was applied, and had a level of heat resistance similar to that of Comparative Example 2 in which only CNT was applied.

When comparing Examples 2-1, 2-2, and Reference Example 2-1 in which the ratio of PEDOT-to-PSS is the same at 1:5 but the ratio of CNT-to-PEDOT:PSS is different, it was confirmed that Examples 2-1 and 2-2 having CNT-to-PEDOT:PSS ratios of 5:95 and 2:98, respectively, had similar levels of high-temperature and high-humidity reliability.

Furthermore, when comparing Examples 2-1, Reference Examples 2-2, 2-3, and 2-4, in which the ratio of CNT-to-PEDOT:PSS is the same at 5:95 but the ratio of PEDOT-to-PSS is different, it was confirmed that Example 2-1 having a PEDOT-to-PSS ratio of 1:5 had the best high-temperature and high-humidity reliability.

From the above experimental examples, it can be confirmed that when PEDOT:PSS and a water-dispersible carbon nanotube manufactured by a chemical vapor deposition method are mixed and applied as conductive materials, heat resistance and moisture resistance are improved, and thus the high-temperature and high-humidity reliability of the antistatic film can be greatly enhanced.

The exemplary embodiments of the present disclosure can also be described as follows:

According to an aspect of the present disclosure, there is provided a display device. A display device includes a display panel, a first polarizing plate disposed below the display panel, a second polarizing plate disposed on the display panel and an antistatic film disposed between the display panel and the second polarizing plate. The antistatic film comprises a silicon-based matrix, and a polythiophene-based compound and a carbon nanotube dispersed in the silicon-based matrix, and the carbon nanotube is a water-dispersible carbon nanotube.

The water-dispersible carbon nanotube may form bundles when water-dispersed, and an average particle diameter D90 of the bundles may be 90 nm to 120 nm.

The water-dispersible carbon nanotube may comprise a single-walled carbon nanotube having an average diameter of 2.0 nm to 4.0 nm.

The water-dispersible carbon nanotube may comprise a single-walled carbon nanotube obtained by a chemical vapor deposition method.

The silicon-based matrix may be a cured product comprising at least one of tetraalkyl orthosilicate and silsesquioxane.

The silsesquioxane may comprise at least one of a random-type silsesquioxane and a cage-type silsesquioxane.

The polythiophene-based compound may be poly(3,4-ethylenedioxythiophene):poly(styrenesulfonate) [PEDOT:PSS].

A weight ratio of the poly(3,4-ethylenedioxythiophene) to the poly(styrenesulfonate) may be 1:4.5 to 1:5.5.

A weight ratio of the carbon nanotube to the polythiophene-based compound may be 5:950 to 2:980.

The display panel may comprise a lower substrate disposed on the first polarizing plate, a liquid crystal layer disposed on the lower substrate, and an upper substrate disposed on the liquid crystal layer.

One end of the antistatic film and the upper substrate may extend further outward than one end of the second polarizing plate, and one end of the lower substrate may extend further outward than one end of the upper substrate and the antistatic film.

The display device may further comprise a grounding pad disposed on the lower substrate that extends further outward than the upper substrate and the antistatic film, and a conductive member connecting the antistatic film and the grounding pad.

The conductive member may be disposed to directly contact a top surface of the antistatic film that extends further than the second polarizing plate, and to cover a side surface of the antistatic film and a side surface of the upper substrate.

The display panel may be an in-cell touch type display panel having a built-in touch sensor.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the claims is not limited by the disclosure, and all the technical concepts in the equivalent scope thereof should be construed as falling within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel;
a first polarizing plate disposed below the display panel;
a second polarizing plate disposed on the display panel; and
an antistatic film disposed between the display panel and the second polarizing plate,
wherein the antistatic film comprises a silicon-based matrix, the silicon-based matrix including a polythiophene-based compound and a carbon nanotube dispersed in the silicon-based matrix, and
wherein the carbon nanotube is a water-dispersible carbon nanotube.

2. The display device according to claim 1, wherein the water-dispersible carbon nanotube forms bundles when water-dispersed, and
wherein an average particle diameter D90 of the bundles is 90 nm to 120 nm.

3. The display device according to claim 1, wherein the water-dispersible carbon nanotube comprises a single-walled carbon nanotube having an average diameter of 2.0 nm to 4.0 nm.

4. The display device according to claim 1, wherein the water-dispersible carbon nanotube comprises a single-walled carbon nanotube obtained by a chemical vapor deposition method.

5. The display device according to claim 1, wherein the silicon-based matrix is a cured product comprising at least one of tetraalkyl orthosilicate and silsesquioxane.

6. The display device according to claim 5, wherein the silsesquioxane comprises at least one of a random-type silsesquioxane and a cage-type silsesquioxane.

7. The display device according to claim 1, wherein the polythiophene-based compound is poly(3,4-ethylenedioxythiophene):poly(styrenesulfonate) [PEDOT:PSS].

8. The display device according to claim 7, wherein a weight ratio of the poly(3,4-ethylenedioxythiophene) to the poly(styrenesulfonate) is 1:4.5 to 1:5.5.

9. The display device according to claim 1, wherein a weight ratio of the carbon nanotube to the polythiophene-based compound is 5:950 to 2:980.

10. The display device according to claim 1, wherein the display panel comprises:
a lower substrate disposed on the first polarizing plate;
a liquid crystal layer disposed on the lower substrate; and
an upper substrate disposed on the liquid crystal layer,
wherein an end of the antistatic film and the upper substrate extend further outward than an end of the second polarizing plate, and
wherein an end of the lower substrate extends further outward than an end of the upper substrate and the antistatic film.

11. The display device according to claim 10, further comprising:
a grounding pad disposed on the lower substrate that extends further outward than the upper substrate and the antistatic film, and
a conductive member connecting the antistatic film and the grounding pad.

12. The display device according to claim 11, wherein the conductive member directly contacts a top surface of the antistatic film that extends further than the second polarizing plate, and the conductive member covers a side surface of the antistatic film and a side surface of the upper substrate.

13. The display device according to claim 1, wherein the display panel is an in-cell touch type display panel having a built-in touch sensor.
